(19) United States
(12) Patent Application Publication
(10) Pub. No.: US 2013/0333556 A1
(43) Pub. Date: Dec. 19, 2013

(54) Pump Piston Structure of Hydraulic Cylinder

(71) Applicant: Kun-Shan Hsu, Chiayi City (TW)

(72) Inventor: Kun-Shan Hsu, Chiayi City (TW)

(21) Appl. No.: 13/495,142

(22) Filed: Jun. 13, 2012

(51) Int. Cl. F16J 1/08

(52) U.S. Cl. 92/172

(57) ABSTRACT

A pump piston structure of a hydraulic cylinder includes a pump piston having an aslant circular groove formed on a circumferential surface of the pump piston and interconnected to a through hole on a distal surface, a movable O-ring installed at the aslant circular groove, a penetrating hole formed between a distal surface of the pump piston and a piston rod and blocked by a pressure valve, and an oil suction hole formed separately on the pump piston and the piston rod for sucking hydraulic oil to push the hydraulic cylinder in the reciprocal movements of the pump piston, and when the hydraulic cylinder is loaded with a heavy object, some of the hydraulic oil at the pump piston returns to the piston rod to reduce the resistance of operating the pump.

### BACKGROUND OF THE INVENTION

1. Field of the Invention

The present invention relates to a pump piston structure of a hydraulic cylinder, and more particularly to the structure having a penetrating hole formed between a pump piston and a piston rod and blocked by a pressure valve, and the pump piston includes an aslant circular groove formed on a circumferential surface of the pump piston and interconnected to a through hole on a distal surface, and a movable O-ring is installed in the aslant circular groove for enhancing the suction efficiency of a hydraulic oil and reducing the resistance of operating a jack.

2. Description of Related Art

In general, the lifting operation of a conventional hydraulic cylinder relies on a pump piston to suck hydraulic oil from an oil suction hole and then push the hydraulic oil into an oil outlet to drive a hydraulic rod, such that a stroke of the hydraulic rod can drive and lift a heavy object.

However, a conventional piston of a jack simply has a piston structure, so that the jack can only output a fixed quantity of hydraulic oil to push the hydraulic rod regardless of whether or not it is at the time when the hydraulic cylinder starts lifting a heavy object (since the resistance differs at the time before/after the hydraulic rod has pushed the hydraulic oil to a position in contact with the heavy object). To achieve a quick lifting effect, the oil suction quantity of the jack is increased. Although the effect of lifting the hydraulic rod quickly can be achieved by increasing the oil suction quantity, yet the resistance of operating the jack is also increased (wherein the impelled quantity of the hydraulic oil is increased for each up-and-down stroke for sucking hydraulic oil, and thus the resistance of the jack is increased). As a result, the hydraulic rod has a very quick lifting stroke before the heavy object is lifted, but the resistance becomes relatively larger as long as the hydraulic rod is loaded with the heavy object, and thus such arrangement has the drawback of requiring much laborious efforts for users to operate the jack. On the other hand, the oil suction quantity of the jack can be reduced to provide an easy operation of the jack loaded with a heavy object, but it takes a longer time before the hydraulic rod can be lifted to a position in contact with the heavy object, and thus such arrangement has the drawback of a time-consuming operation.

### SUMMARY OF THE INVENTION

Therefore, it is a primary objective of the present invention to provide a pump piston structure of a hydraulic cylinder, particularly the structure with a pump piston having an aslant circular groove formed on a circumferential surface of the pump piston and interconnected to a through hole on a distal surface, a movable O-ring installed at the aslant circular groove, a penetrating hole formed between a distal surface of the pump piston and a piston rod and blocked by a pressure valve, and an oil suction hole formed separately on the pump piston and the piston rod for sucking hydraulic oil to push the hydraulic cylinder in reciprocal movements of the pump piston, so that the invention can achieve the following effects:

Since the jack of the present invention has an oil suction hole interconnected to the pump piston and the piston rod separately, and the pump piston has an aslant circular groove formed on a circumferential surface of the pump piston and interconnected to a through hole on a distal surface, and a movable O-ring is installed at the aslant circular groove, therefore when the hydraulic rod is lifted to a position not in contact with the heavy object yet, the hydraulic oil at the pump piston can be outputted when the jack is pressed down, and the hydraulic oil at the piston rod is sucked. When the jack is pushed upward, the hydraulic oil at the pump piston can be sucked through the oil suction hole, and the hydraulic oil at the piston rod can flow through the aslant circular groove and the through hole to the pump piston, so that the jack can be operated more efficiently in the process of sucking hydraulic oil. Further, when the hydraulic rod starts loading a heavy object to produce a greater resistance, the jack is pressed down to drive the pump piston to push the hydraulic oil and thus also produces a larger pressure. As a result, the pressure of the hydraulic oil at the pump piston can push open the pressure valve and let a part of the hydraulic oil flow towards the piston rod and the other part of the hydraulic oil be outputted to the oil outlet, so as to push the hydraulic rod (wherein the cross-sectional area of the hydraulic oil at the pump piston is greater than the cross-sectional area of the piston rod. In the operations of the same jack, the output quantity of the hydraulic rod hydraulic oil drops automatically to assure an easy operation of lifting the heavy load when the heavy object is loaded, so as to achieve the effect of lifting the hydraulic rod quickly before the heavy object is lifted and the advantage of reducing the resistance of operating the jack after the heavy object is lifted.

### BRIEF DESCRIPTION OF THE DRAWINGS

FIG. 1 is an exploded view of a jack of the present invention;

FIG. 2 is a cross-sectional view of a hydraulic cylinder of the present invention;

FIG. 3 is a cross-sectional view of a jack of the present invention;

FIG. 4 is a schematic view of an application of the present invention;

FIG. 5 is a schematic view of a pump piston moving upward in accordance with the present invention;

FIG. 6 is a schematic view of a pump piston moving downward in accordance with the present invention; and

FIG. 7 is a schematic view of a pump piston moving downward with a load in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

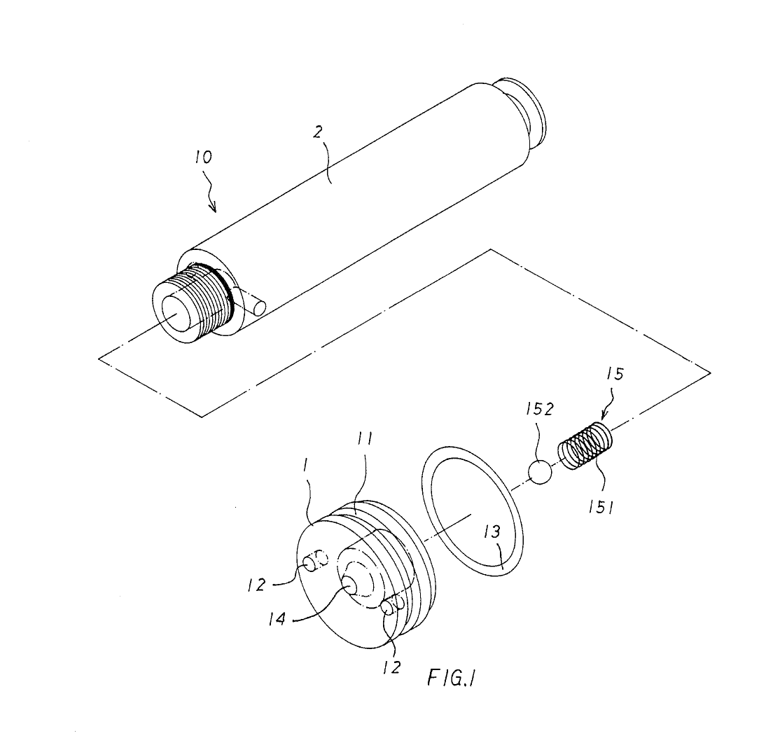

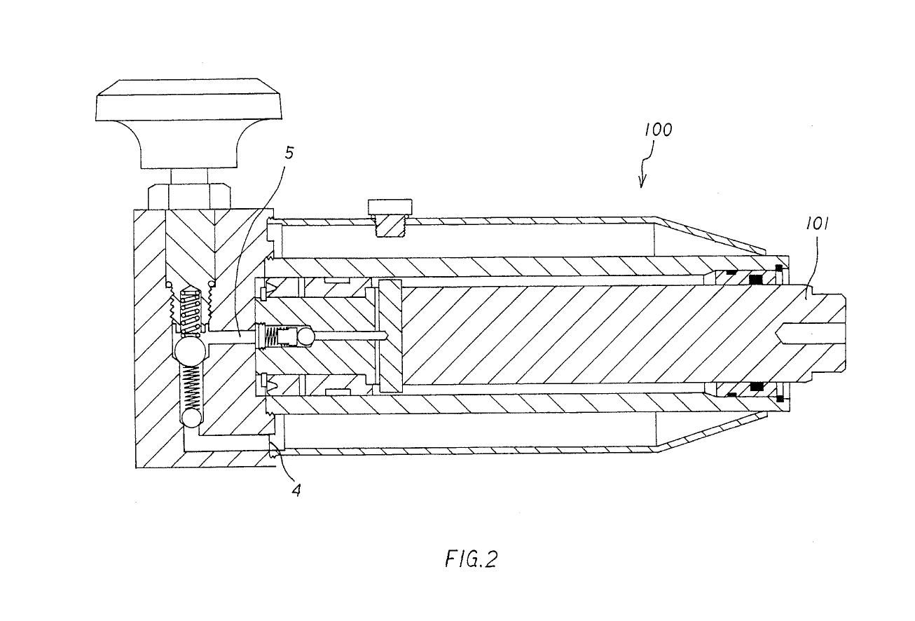

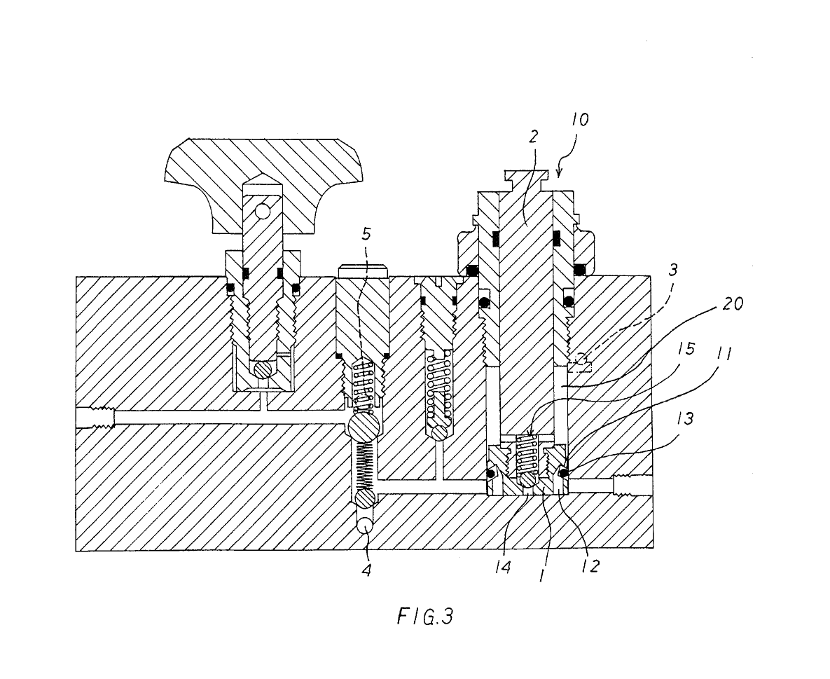

With reference to FIG. 1 for a pump piston structure of a hydraulic cylinder in accordance with the present invention, a pump piston 1 is installed in an oil chamber 20 for pushing hydraulic oil, and the pump piston 1 has an aslant circular groove 11 formed on a circumferential surface of the pump piston 1 and interconnected to a through hole 12 on a distal surface (as shown in FIG. 1). A movable O-ring 13 disposed in the aslant circular groove 11 abuts an inner wall of an oil chamber 20. A penetrating hole 14 is formed between the distal surface of the pump piston 1 and the piston rod 2 and blocked by a pressure valve 15. Oil suction holes 3, 4 are formed at upper and lower ends of the oil chamber 20 and corresponding to the piston rod 2 and the pump piston 1 respectively. The pump 10 is operated reciprocally to supply hydraulic oil to a hydraulic cylinder 100 (as shown in FIGS. 2 and 3).

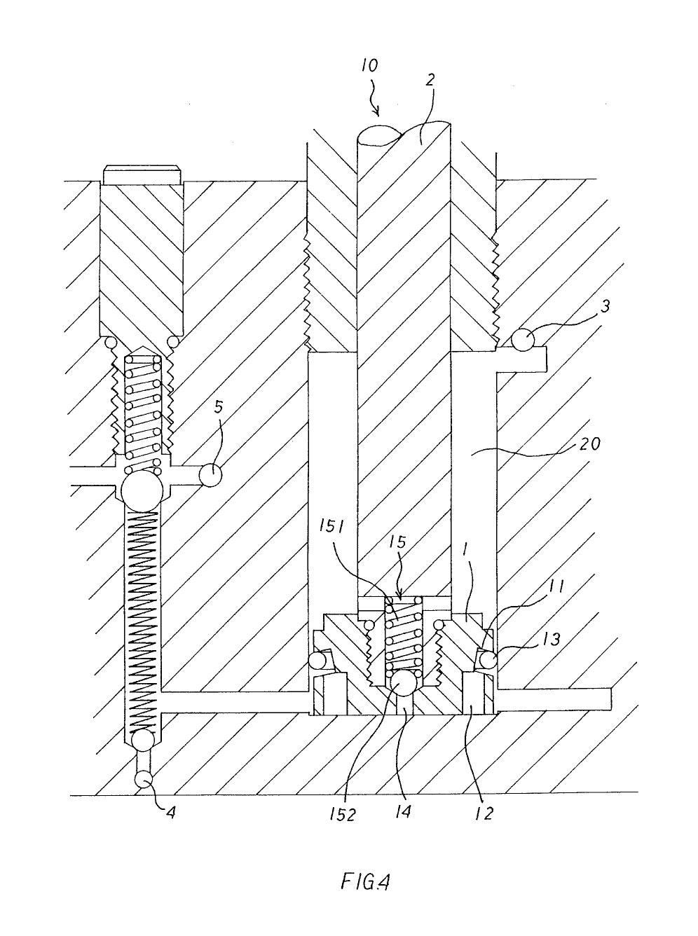

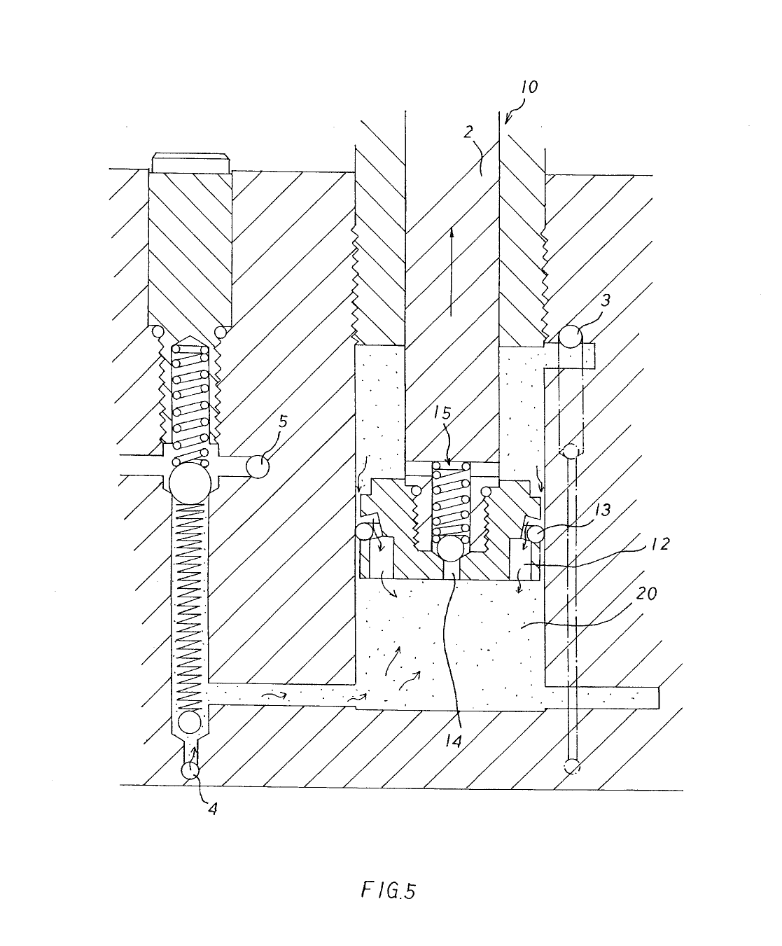

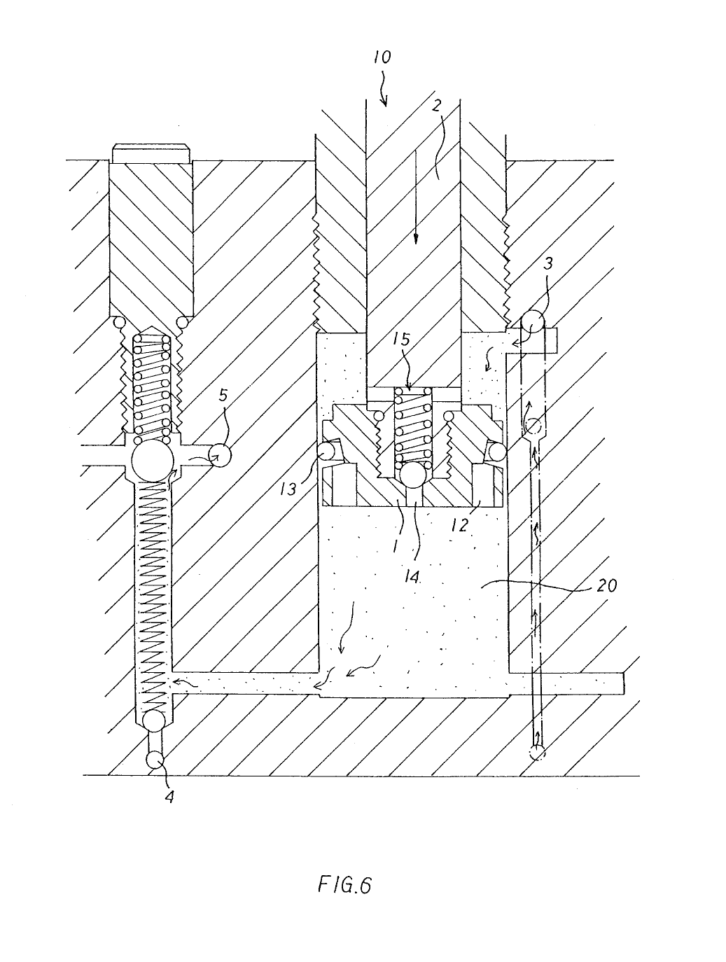

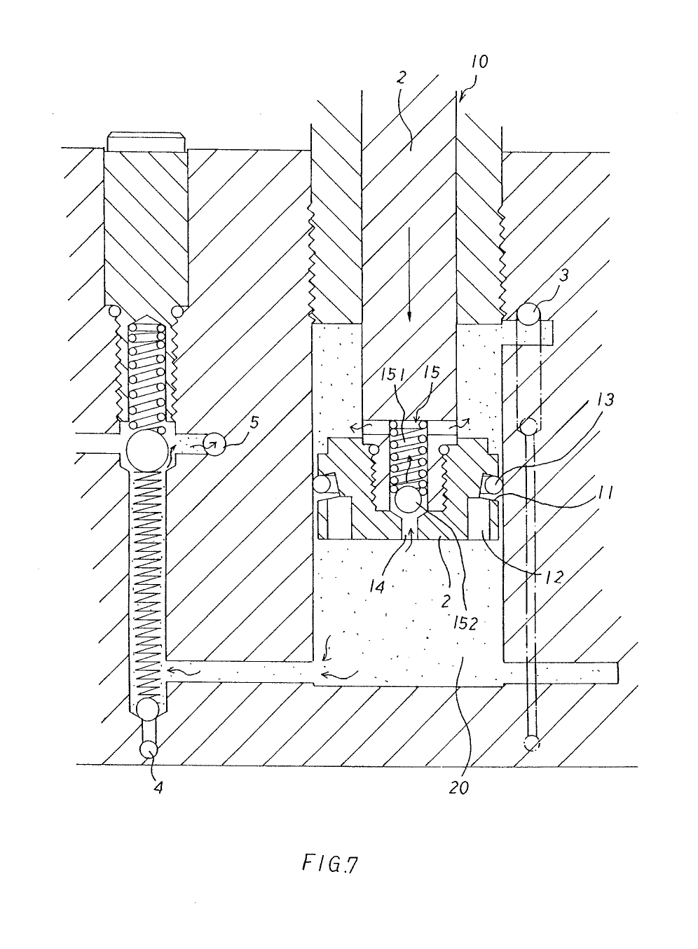

With the aforementioned components, the piston rod 2 of the pump 10 drives the pump piston 1 to move up and down reciprocally in the oil chamber 20. Since the pump piston 1 is abutted against the inner wall of the oil chamber 20 through the movable O-ring 13 (as shown in FIG. 4), therefore when the pump piston 1 moves upward, the movable O-ring 13 slides to a lower position inside the aslant circular groove 11. When the pump piston 1 moves downward, the movable O-ring 13 slides to an upper position inside the aslant circular groove 11. Therefore, if the hydraulic rod 101 of the hydraulic cylinder 100 is not in contact with a heavy object, the pump piston 1 moving upward produces a suction force at the oil suction hole 4 to suck the hydraulic oil into the space of the oil chamber 20 below the pump piston 1 (as shown in FIG. 5). Now, the hydraulic oil at the piston rod 2 passes through the aslant circular groove 11 and the through hole 12 into a space below the pump piston 1 to enhance the oil suction efficiency of the pump piston 1. When the pump piston 1 moves downward, the movable O-ring 13 is situated at the upper part inside the aslant circular groove 11 to shut the through hole 12 (as shown in FIG. 6). As a result, a vacuum suction is produced at the piston rod 2 to suck the hydraulic oil into the oil suction hole 3, and the hydraulic oil below the pump piston 1 is pushed to the oil outlet 5, so that the hydraulic rod 101 can obtain power to be lifted. Further, the hydraulic rod 101 can be lifted to the position of the heavy object quickly. Wherein, the oil suction holes 3, 4 and oil outlet 5 come with a check valve each, and conventional components such as pressure regulating valves, high or low pressure valves, or oil return valves can be installed in an oil path, if needed. These conventional components are prior art, and thus they are not described in details here. When the hydraulic rod 101 starts lifting the loaded heavy object, the pressure (resistance) required for pushing the hydraulic oil into the oil outlet 5 increases, so that when the pump piston 1 moves downward, the impelling pressure causes some of the hydraulic oil below the pump piston 1 to prop open the pressure valve 15 and flow from the penetrating hole 14 to the piston rod 2 (as shown in FIG. 7) to achieve a pressure relief effect of the diverted oil. Now, the vacuum suction produced at the piston rod 2 can suck hydraulic oil through the pressure valve 15 only, but it has no effect on the oil suction hole 3). The other part of the hydraulic oil is impelled into the oil outlet 5, so that the quantity of hydraulic oil outputted by the pump 10 becomes less and less in every stroke to achieve a resistance reduction effect and provide an easy operation for users.

When the pump piston 1 moves upward, the hydraulic oil at the piston rod 2 and the oil suction hole 4 is filled into the space below the pump piston 1 to allow the users to operate the pump 10 reciprocally.

The pressure valve 15 is formed by using a spring 151 to prop a bead 152 to seal a penetrating hole 14.

In summation of the description above, the pump piston 1 of the present invention can lift the hydraulic rod 101 quickly before lifting a heavy object. When the hydraulic rod 101 is loaded with the heavy object, the output quantity of hydraulic oil is reduced automatically to assure that users can lift the heavy object easily.

While we have shown and described various embodiments in accordance with the present invention, it is clear to those skilled in the art that further embodiments may be made without departing from the scope of the present invention.

What is claimed is:

1. A pump piston structure of a hydraulic cylinder comprising:
a pump piston installed in an oil chamber for pushing hydraulic oil,
an aslant circular groove formed on a circumferential surface of the pump piston and interconnected to a through hole on a distal surface of the pump piston;
a movable O-ring slidably disposed in the aslant circular groove and abutted against an inner wall of the oil chamber;
a penetrating hole formed between a distal surface of the pump piston and a piston rod and blocked by a pressure valve; and
an oil suction hole interconnected at upper and lower ends of the oil chamber separately and corresponding to the piston rod and the pump piston for sucking the hydraulic oil to push and lift the hydraulic rod during reciprocal movements of the pump piston;
thereby, after the hydraulic rod is loaded with a heavy object, the pressure valve is provided for diverting the hydraulic oil to the piston rod to reduce the impelled quantity of the hydraulic oil and the resistance of operating a jack.

2. The pump piston structure of a hydraulic cylinder of claim 1, wherein the pressure valve is formed by using a spring to abut a bead to seal the penetrating hole.
